(19) United States
(12) Patent Application Publication
(10) Pub. No.: US 2026/0249499 A1
(43) Pub. Date: Aug. 27, 2026

(54) CUTTING KNIFE WITH KNIFE BLADE AND KNIFE HOLDER

(71) Applicant: TKM GmbH, Remscheid (DE)

(72) Inventors: Udo Middendorf, Remscheid (DE); Sebastian Joachim Opiolka, Remscheid (DE)

(73) Assignee: TKM GmbH, Remscheid, OT (DE)

(21) Appl. No.: 18/726,378

(22) PCT Filed: Dec. 5, 2022
(86) PCT No.: PCT/EP2022/084447

§ 371 Date: Jul. 2, 2024

(30) Foreign Application Priority Data
Feb. 3, 2022 (DE) 10 2022 102 557.8

(51) Int. Cl. B26D 1/00; B26D 1/08; B26D 7/00; B26D 7/26

(52) U.S. Cl. CPC B26D 1/0006; B26D 1/085; B26D 7/2614; B26D 2001/0053; B26D 2001/006; B26D 2007/0081

(57) ABSTRACT

A cutting knife which is designed as the upper knife of a guillotine knife, three-way knife or trimmer knife for cutting paper, cardboard, cartons and/or plastic films. The cutting knife has a knife holder with a detachably fastened knife blade and is movably mounted for carrying out a shear cut, parallel cut, parallel oblique cut, vertical swing cut or oblique swing cut. The knife blade is held on the knife holder in a force-fitting and form-fitting manner. The knife blade has a cutting edge region and a clamping region and is mounted in the clamping region between two clamping bodies of the knife holder. Corresponding form-fitting elements are formed on the knife blade and on the knife holder, which engage when the cutting knife is in the assembled state.

### CROSS-REFERENCE TO RELATED APPLICATIONS

This application is the U.S. National Stage application of International Application No. PCT/EP2022/084447, filed on Dec. 5, 2022, which international application was published on Aug. 10, 2023, as International Publication WO 2023/147915 A1 in the English language. The international application is incorporated herein by reference, in its entirety. The international application claims priority from German Patent Application No. 102022102557.8, filed on Feb. 3, 2022, which is incorporated herein by reference, in its entirety.

The invention relates to a cutting knife which is configured as the upper knife of a guillotine knife, three-way knife or trimmer knife for cutting paper, cardboard, cartons and/or plastic films. The cutting knife has a knife holder with a detachably fastened knife blade and is movably mounted for performing a shear cut, parallel cut, parallel oblique cut, vertical swing cut or oblique swing cut.

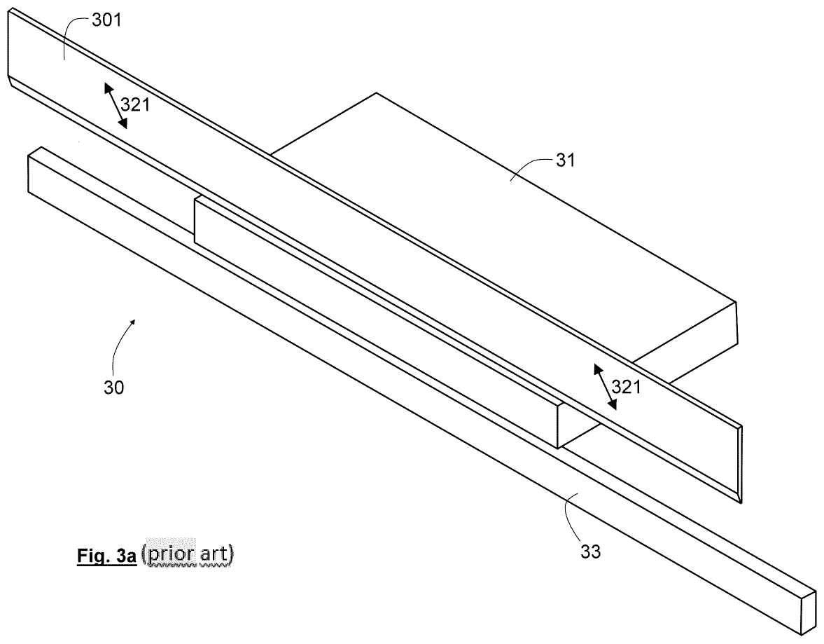

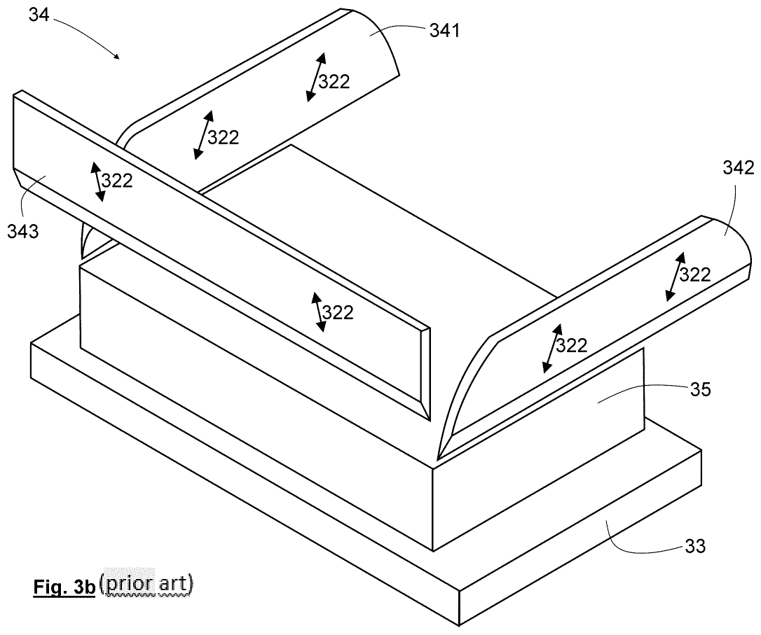

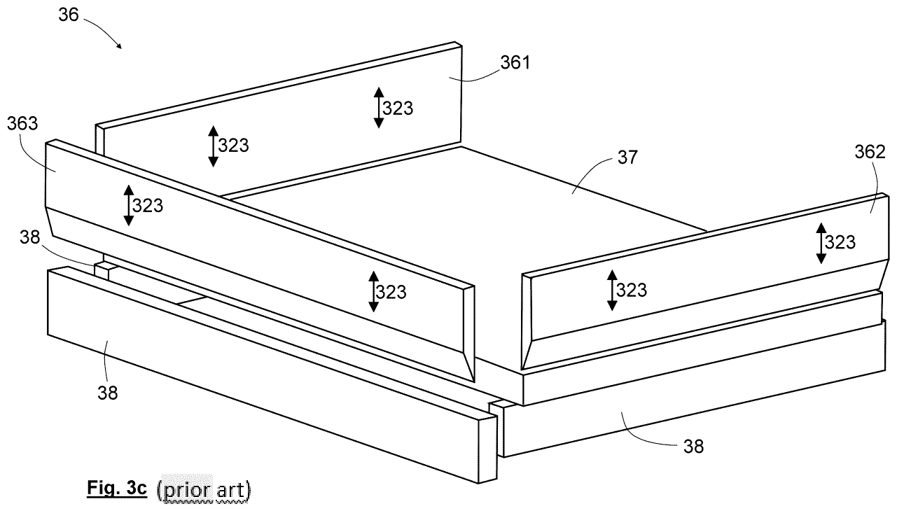

Cutting knives of the type mentioned at the beginning are known from prior art and are configured for cutting through clamped stacks of sheets of paper or plastic film as well as cardboard, cartons or other substrates. A distinction must be made between guillotine knives, three-way knives and trimmer knives, as shown schematically in FIG. 3a, b, c.

FIG. 3a shows a guillotine knife 30 with which printed sheets 31 are cut into bookbinding sheets in the illustrated embodiment example. Alternatively, guillotine knives 30 of the type shown are used in particular to cut labels, cardboard, cartons, banknotes, forms and book covers. The guillotine knife 30 possesses a cutting knife 301 which performs an oblique swing cut in the arrow direction 321 against a cutting strip 33, wherein the so-called panel is cut. Said cutting strips 33 are usually made of wood or plastic.

FIG. 3b shows a three-way knife 34 with three cutting knives 341, 342, 343 aligned at an angle to each other, which in the illustrated embodiment example cut a book block 35. With the three-way knife 34, the movement of the cutting knives 341, 342, 343 is carried out in an oblique swing cut along the arrow directions 322 against a block spine and against cutting strips 33. The cut involves several working cycles, namely the cutting of the block spine in the front cut and the cutting of the head and foot cut.

Finally, FIG. 3c shows a trimmer knife 36 with three cutting knives 361, 362, 363 aligned at an angle to one another, which in the embodiment example shown cut a clamped sheet stack 37. The cutting knives 361, 362, 363 of a trimmer knife 36 usually perform a parallel cut, so that the cutting knives 361, 362, 363 are guided in the arrow direction 323, wherein with the trimmer knife 36, the cutting knife 361, 362, 363 configured as an upper knife works against a lower knife 38 in the so-called scissor cut.

Cutting knives are known from prior art, the knife blades of which are glued or soldered to a knife holder and are therefore inseparably connected to the knife holder. Worn knife blades can be reground approx. 20 times before they have to be replaced together with the knife holder. Such cutting knives have proven to be disadvantageous because regrinding is associated with high labor and logistics costs and the regular disposal of the complete cutting knife requires a high material input.

Cutting knives have therefore been developed in which the knife blades are detachably attached to the knife holder so that the knife blades can be replaced due to wear without having to dispose of the knife holder.

For example, from DE 41 10 039 C3 a guillotine knife is known, the knife blade of which is attached to a base body (knife holder) by means of screws. However, these screws are subjected to high loads during cutting. Furthermore, to replace a knife blade, all screws must be completely loosened and tightened together with the new knife blade, which is associated with a high amount of work during the fitting and removal of a knife blade.

DE 10 2016 123 079 A1 discloses a multi-part long knife with an elongated knife carrier (knife holder) and at least one elongated knife blade with a cutting edge, wherein the knife carrier has a clamping strip which is guided in a recess of the knife carrier in a clamping device. An accommodation for the knife blade is formed between the knife carrier and the clamping strip guided in the recess, wherein a first clamping surface is formed at the knife carrier and a second clamping surface opposite the first clamping surface is formed at the clamping strip, between which the knife blade can be clamped.

Known cutting knives with knife blades that are detachably attached to a knife holder have proven to be disadvantageous, in particular because replacing the knife blades is time-consuming and the knife bearing does not sufficiently meet the requirements for stability. In some cases, geometric changes had to be made to the knife holders to make their use possible. However, these had disadvantageous effects on the actual function of the cutting knifes.

It is therefore the task of the present invention to create a cutting knife with which the knife blade is securely held even at high loads and the structure of which provides easy handling during fitting and removal of the knife blade. In particular, the fastening should provide a positional fixation that is always reproducible to the same extent with regard to the knife holder.

This task is solved by the cutting knife according to claim 1. According to the invention, it is provided that the knife blade is held on the knife holder in a force-fitting and form-fitting manner. For this purpose, the knife blade has a cutting edge region and a clamping region and is clamped in the clamping region between two clamping bodies of the knife holder. Furthermore, correspondingly designed form-fitting elements are formed on the knife blade and on the knife holder, which engage in one another when the cutting knife is assembled. The first-mentioned measure serves to securely fix the knife blade by clamping it between two clamping bodies of the knife holder. The second measure is a simple way of always fixing the knife blade in the knife holder with the same precision without major adjustment work, because form-fitting elements always provide the same positional fixation. Despite the form-fitting mounting of the knife blade on the knife holder in the assembled state, the clamping bodies do not have to be completely released from each other in order to fit or remove the knife blade. This also reduces the assembly effort when replacing a knife blade without negatively affecting the positional stability.

Preferred embodiments of the present invention are described below and in the sub-claims.

In the context of a first preferred embodiment of the invention, it is provided that the form-fitting elements are formed on the knife blade side by at least two recesses, in particular by at least two grooves, and on the knife holder side by at least two correspondingly formed projections, which are preferably formed as pins and engage into the grooves of the knife blade in the assembled state of the cutting knife. This preferred embodiment has the particular advantage that it results in a form-fitting mounting of the knife blade that acts in all directions that are aligned parallel to the clamping surfaces of the knife blade. Above all, the form-fitting blocks a displacement of the knife blade parallel to the cutting edge, which leads to a particularly stable mounting of the knife blade when performing a shear cut, parallel oblique cut and oblique swing cut, because considerable forces occur parallel to the cutting edge, especially during these cutting movements. The recesses/grooves are preferably configured threadless and are thus formed exclusively for form-fitting mounting of the knife blade on the knife holder. Preferably, two spaced recesses/grooves are used in the knife blade with corresponding projections on the clamping bodies of the knife holder. For the purposes of the present invention, it is of course also possible to form the recesses in the surfaces of the clamping bodies of the knife holder and the corresponding projections on the surface of the knife blade. An alternating arrangement is also possible, in which a knife blade has both recesses/grooves and projections/springs which engage in correspondingly formed and positioned recesses/grooves and projections/springs which are formed on at least one of the clamping bodies of the knife holder. In practice, however, two spaced recesses are preferably selected on the knife blade surface, in particular in the form of grooves which are arranged adjacent to opposite side edges of the knife blade.

According to a further preferred embodiment of the invention, it is provided that the clamping surfaces of the knife blade and the knife holder are aligned in such a way that the normal force causing the frictional connection is aligned orthogonally to the plane of movement of the cutting knife. As a result, the clamping surfaces on the knife holder as well as on the knife blade are aligned parallel to the plane of movement of the cutting knife, which as far as possible reduces any possible bending forces that would otherwise act on the knife blade. The special mounting of the knife blade in the knife holder thus reduces wear-related breakage of the knife blades, resulting in a significant increase in the achievable service life of a knife blade.

In a preferred embodiment of the invention, it is provided that the depth of the recesses/grooves is greater than or equal to the height of the projections/springs.

The depth of the recesses/grooves is preferably greater than the height of the projections/springs in order to prevent the clamping body from resting on the projections/springs, which would have a negative effect on the clamping mounting of the knife blade within the knife holder. Nevertheless, the comparatively flat projections/springs provide sufficient form-fitting to prevent the knife blade from shifting even if the knife blade is loosely clamped.

Preferably, the clamping bodies of the knife holder have a stepped contact surface.

Viewed in cross-section, the knife blade is preferably L-shaped, wherein the long leg of the knife blade forms the clamping region and the short leg of the knife blade forms the cutting edge region, which protrudes freely from the knife holder. The cutting edge region is preferably formed by two surfaces arranged at an angle to each other, which form an angle of 22°±5° in a specific embodiment. Preferably, one of the surfaces is aligned parallel to the plane of movement.

Viewed in cross-section, the cutting edge region forms an essentially triangular shape, wherein the cutting edge region has a contact surface on the side facing away from the cutting edge, which is in contact with the first clamping body of the knife holder.

The clamping region of the knife preferably also extends parallel to the plane of movement of the cutting knife and is preferably engaged from behind at least in sections by the second clamping body of the knife holder. For this purpose, both the clamping region of the knife blade and the clamping body of the knife holder can have an angled but correspondingly formed contact surface. Alternatively, a stepped undercut is provided, which is formed on the second clamping body and in which the knife blade engages.

Finally, as part of a further preferred embodiment of the invention, it is provided that the two clamping bodies of the knife holder have several holes outside the clamping region for the knife blade to accommodate fastening screws. The fastening screws do not penetrate the knife blade, which is why on the one hand they only contribute to the clamping fixation of the knife blade and on the other hand do not necessarily have to be completely loosened for fitting and removal. It is usually sufficient to loosen the screws sufficiently to allow the knife blade to be removed from the knife holder.

A specific embodiment of the present invention and further preferred embodiments are explained below with reference to the figures.

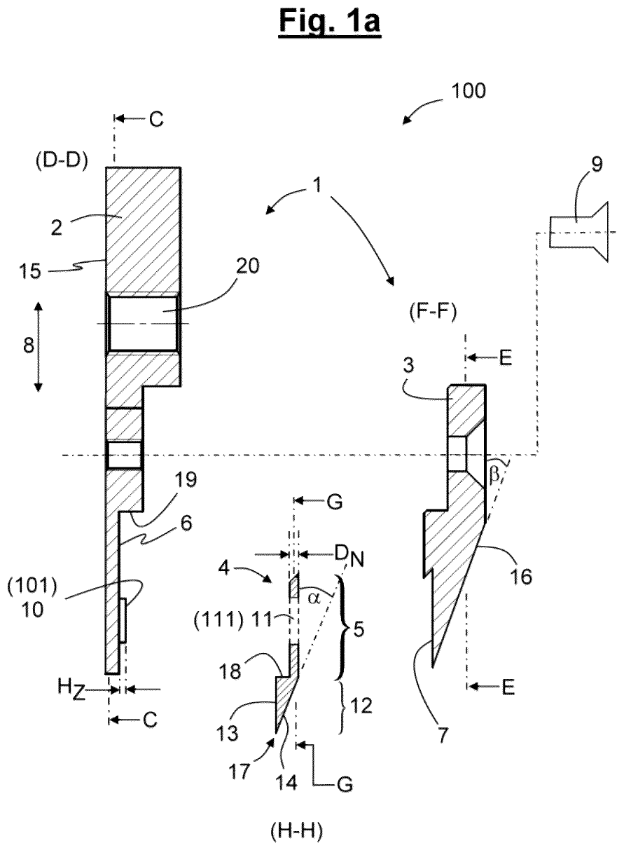

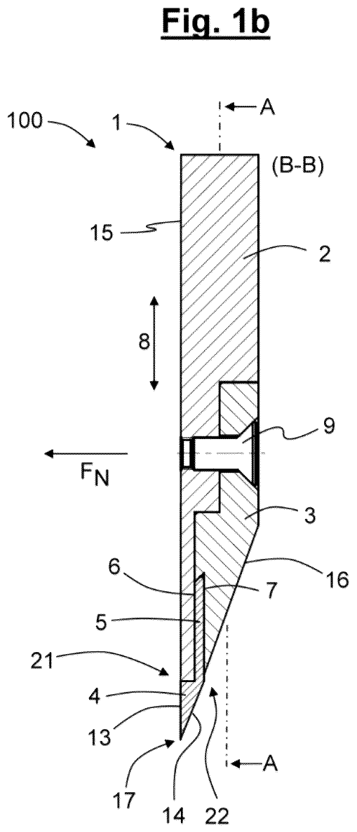

FIG. 1 a, b shows cross-sectional views of a knife holder with a knife,

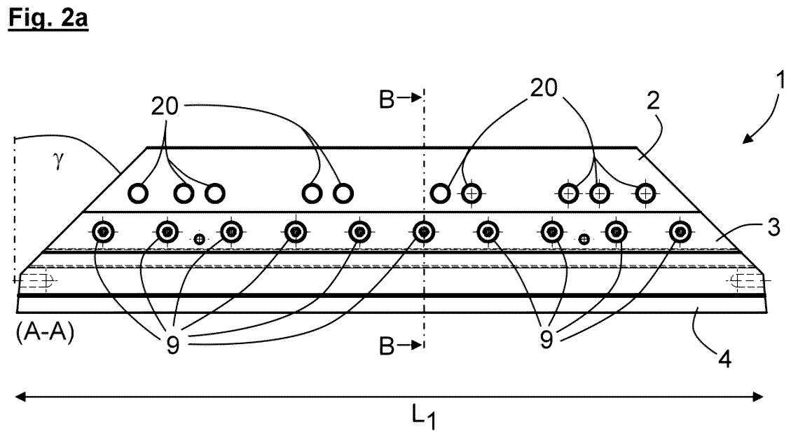

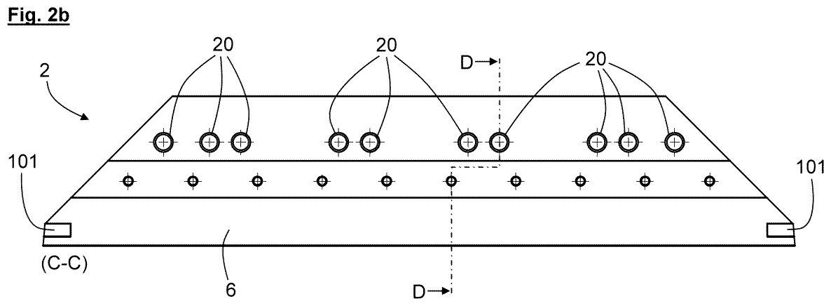

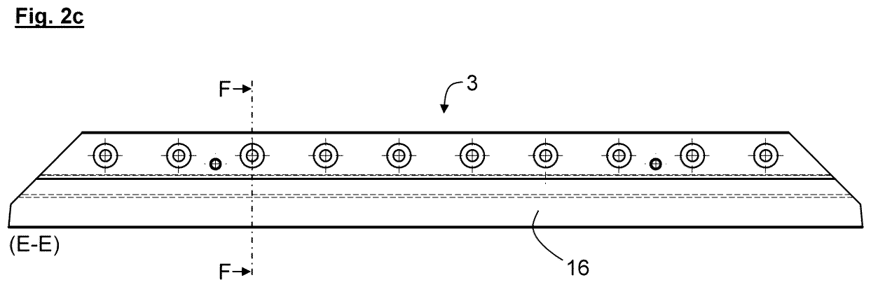

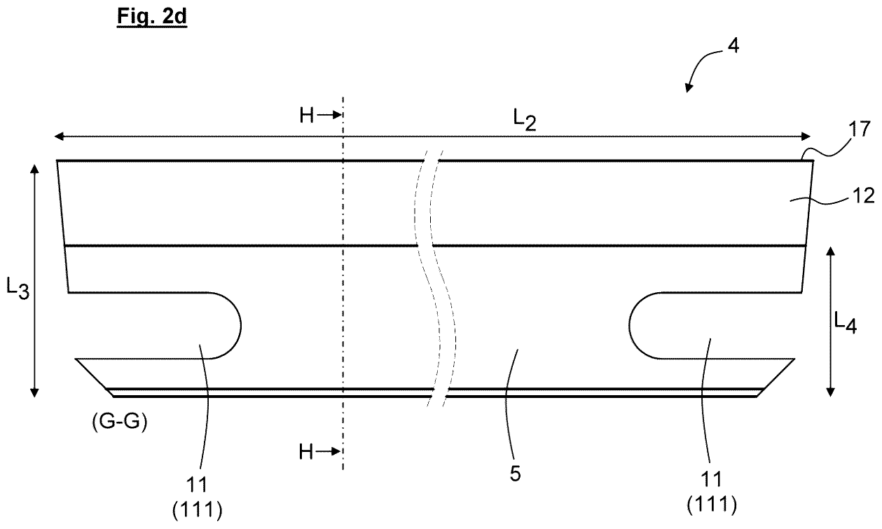

FIG. 2a shows a top view of the knife holder with a knife,

FIG. 2b shows a top view of a first clamping body,

FIG. 2c shows a top view of a second clamping body,

FIG. 2d shows a top view of a knife,

FIG. 3a shows a perspective view of a guillotine knife,

FIG. 3b shows a perspective view of a three-way knife and

FIG. 3c shows a perspective view of a trimmer.

FIGS. 1a, b each show a cutting knife 100 with a knife holder 1 and a knife blade 4 both in an exploded view (FIG. 1a) and in the assembled state (FIG. 1b). The knife holder 1 possesses a first clamping body 2 and a second clamping body 3, which are detachably connected to the knife blade 4, wherein the knife blade 4 is mounted both in a form-fitting as well in a force-fitting manner in the knife holder 1 for this purpose. For the force-fitting mounting of the knife blade 4, the knife blade 4 possesses a clamping region 5 which, in the assembled state, extends between two clamping surfaces 6, 7 of the clamping bodies 2, 3. The clamping region 5 of the knife blade 4 as well as the clamping surfaces 6, 7 of the clamping bodies 2, 3 are aligned parallel to the plane of movement 8 of the cutting knife 100. The clamping force FN is applied by several screws 9, which pass through both clamping bodies 2, 3—but not the knife blade 4. The clamping force FN is aligned orthogonally to the plane of movement 8. In addition to the force-fitting mounting, the knife blade 4 is force-fittingly connected to the knife holder 1. For this purpose, the first clamping body 2 has form-fitting elements in the form of projections 10, in particular in the form of pins 101, which engage in recesses 11 in the form of grooves 111, which are fitted and positioned in the knife blade 4. The depth DN of the grooves 111 is greater than the height Hz of the pins 101, which prevents the clamping surface 7 of the second clamping body 3 from coming into contact with the pins 101 of the first clamping body 2, which could otherwise have a negative effect on the clamping action. Both the form-fitting elements in the form of the projections 10 and the recesses 11 in the form of the grooves 111 are threadless.

The cutting edge region 12 of the knife blade 4 is flanked by a first surface 13 and a second surface 14, which are aligned at an angle α of 22° to each other. The first surface 13 is aligned parallel to the clamping region 5 of the knife blade 4 and therefore also to the plane of movement 8 of the cutting knife 100. The first surface 13 of the cutting edge region 12 merges into the outer surface 15 of the first clamping body 2 with a small step-shaped offset (arrow 21) of approx. 0.1 mm, which is why the first surface 13 of the cutting edge region 12 has a small projection. In an alternative embodiment, a flush and step-free transition is also provided.

The second surface 14 of the cutting edge region 12 also transitions in steps into the outer surface 16 of the second clamping body 3 (arrow 22), wherein its surface 16 has an angle β of 20° relative to the plane of movement 8 of the cutting knife 100. A flush, step-free and equiangular transition is also provided for these surface transitions as part of an alternative embodiment.

On the side of the cutting edge region 12 facing away from the cutting edge 17, a contact surface 18 is formed on the knife blade 4, which in the assembled state of the cutting knife 100 rests against an end face 19 of the first clamping body 2, whereby the knife blade 4 is supported when a cut is made.

FIG. 2a shows the assembled knife holder 1 according to FIG. 1b in a plan view of the plane A-A. FIG. 1b is therefore a cross-sectional view along plane B-B. The clamping bodies 2, 3 of the knife holder 1 are connected to each other with a total of ten screws 9 in the illustrated embodiment example. The knife holder 1 shown has a length L1 of 409 mm, wherein the right and left ends are beveled at an angle γ of 45°. To attach the knife holder 14 to a support (not shown), a further ten bore holes 20 are also provided, which are formed to accommodate fastening screws (not shown).

FIG. 2b shows the first clamping body 2 according to FIG. 1a in a top view of the plane C-C. In FIG. 1a, the first clamping body 2 is therefore shown along the cross-sectional plane D-D. In the region of the clamping surface 6, the first clamping body 2 possesses form-fitting elements in the form of two pins 101, which are arranged to the right and left of the clamping surface 6. The pins 101 are precisely formed and arranged to engage in grooves 111 of the knife blade 4 in the assembled state, so that the knife blade 4 is mounted in a form-fitting manner.

FIG. 2c shows the second clamping body 3 according to FIG. 1a in a top view of the plane E-E. In FIG. 1a, the second clamping body 3 is therefore shown along the cross-sectional region F-F.

Finally, FIG. 2d shows the knife blade 4 according to FIG. 1a in a plan view of the plane G-G. In FIG. 1a, the knife blade 4 is therefore shown along the cross-sectional plane H-H. The knife blade 4 is shown with its clamping region 5, in which grooves 11 are formed on the right and left sides to accommodate the form-fitting elements 10, 101. The cutting edge region 12 with the cutting edge 17 extends above this. The knife blade 4 possesses a length L₂ of 409 mm, a depth L₃ of 25 mm and a thickness D_{N} of 1.4 mm in the clamping region 5 (see FIG. 1a). The clamping region 12 has a depth L₄ of 16 mm.

1. A cutting knife, which:
is configured as an upper knife of a guillotine knife, three-way knife or trimmer knife for cutting paper, cardboard, cartons and/or plastic films, and
has a knife holder with a detachably fastened knife blade and
is movably mounted for performing a shear cut, parallel cut, parallel oblique cut, vertical swing cut or oblique swing cut,
where the knife blade is mounted in a force-fitting and form-fitting manner on the knife holder, for which purpose:
the knife blade has a cutting edge region and a clamping region and is clamped in the clamping region between two clamping bodies of the knife holder, and
corresponding form-fitting elements are formed on the knife blade and on the knife holder, which engage in one another when the cutting knife is in the assembled state.

2. The cutting knife according to claim 1, wherein, the form-fitting elements are formed on the knife blade side by at least two recesses, in particular at least two grooves, and on the knife holder side by at least two correspondingly formed projections, which are preferably formed as pins and engage in the grooves of the knife blade in the assembled state of the cutting knife.

3. The cutting knife according to claim 1, wherein, the clamping surfaces of the knife blade and the knife holder are aligned in such a way that the normal force causing the frictional connection is aligned orthogonally to the plane of movement of the cutting knife

4. The cutting knife according to claim 2, wherein the depth D_{F} of the recesses/grooves is greater than or equal to the height Hz of the projections/pins.

5. The cutting knife according to claim 1, wherein, the clamping bodies of the knife holder have a stepped contact surface.

6. The cutting knife according to claim 1, wherein the knife blade is essentially L-shaped when viewed in cross-section, wherein the long leg of the knife blade forms the clamping region and the short leg of the knife blade forms the cutting edge region which projects freely from the knife holder.

7. The cutting knife according to claim 1, wherein the cutting edge region is formed by two surfaces arranged at an angle to one another, wherein a first surface is preferably aligned parallel to the plane of movement of the cutting knife.

8. The cutting knife according to claim 1, wherein the cutting edge region has, on the side facing away from the cutting edge, a contact surface which is in contact with a first clamping body of the knife holder.

9. Cutting knife according to claim 1, wherein the clamping region of the knife blade extends parallel to the plane of movement of the cutting knife.

10. The cutting knife according to claim 1, wherein the clamping region of the knife blade is engaged at least in sections by the second clamping body of the knife holder.

11. The cutting knife according to claim 1, wherein the two clamping bodies of the knife holder have several holes for receiving fastening screws outside the clamping region for the knife blade.
